(19) United States
(12) Patent Application Publication
(10) Pub. No.: US 2011/0207618 A1
(43) Pub. Date: Aug. 25, 2011

(54) CLASS LABEL PREDICTING APPARATUS AND METHOD

(75) Inventors: Sang Hyun Park, Seoul (KR); Jae Gyoon Ahn, Seoul (KR); Eun Ji Shin, Seoul (KR); Young Mi Yoon, Seoul (KR)

(73) Assignee: Industry-Academic Cooperation Foundation, Yonsei University, Seoul (KR)

(21) Appl. No.: 12/712,161

(22) Filed: Feb. 24, 2010

(30) Foreign Application Priority Data
Feb. 19, 2010 (KR) 10-2010-0015332

(51) Int. Cl. C40B 30/02; C40B 60/12

(52) U.S. Cl. 506/8; 506/39

(57) ABSTRACT

According to an embodiment of the present invention, it is possible to rapidly and accurately predict a class label of a predetermined test sample by extracting a disease-specific gene pair from gene pairs on a microarray data set representing an expression level for each of genes of a genome and for each of a plurality of samples by considering the correlation in a normal class and the correlation in a disease class, selecting a highest specific gene pair with the highest correlation among the extracted disease-specific genes, and predicting the class label of the predetermined test sample by using the selected highest specific gene pair.

### BACKGROUND OF THE INVENTION

1. Field of the Invention

The present invention relates to a gene, and more particularly, to a class label predicting method of a predetermined sample from information on an expression level on microarray data set.

2. Description of the Related Art

A microarray data set means array-type data representing an expression level for each of genes of a genome and for each of a plurality of samples.

According to a known prediction method, the number of genes considered in predicting a class label of a predetermined sample by using expression levels on the microarray data set is large, such that the considerable quantity of calculations is required for the prediction and in addition, prediction accuracy is also low.

### SUMMARY OF THE INVENTION

An object of the present invention is to provide a class label predicting apparatus capable of rapidly and accurately predicting a class label of a predetermined sample by selecting only relevant genes in predicting the class label from genes on a microarray data set and considering only the selected genes.

Another object of the present invention is to provide a class label predicting method capable of rapidly and accurately predicting a class label of a predetermined sample by selecting only relevant genes in predicting the class label from genes on a microarray data set and considering only the selected genes.

Yet another object of the present invention is to provide a recording medium readable with a computer and stored with computer programs to rapidly and accurately predict a class label of a predetermined sample by selecting only relevant genes in predicting the class label from genes on a microarray data set and considering only the selected genes.

In order to achieve the above-mentioned object, according to an embodiment of the present invention, a class label predicting apparatus includes: an extractor extracting disease specific gene pairs from gene pairs on a microarray data set, which show expression levels for each of genes of a genome and for each of a plurality of samples by considering the correlation in a normal class and the correlation in a disease class; a selector selecting a top specific gene pair having the highest correlation from the extracted disease specific genes; and a label predictor predicting a class label of a predetermined test sample by using the selected top specific gene pair.

Herein, the extractor may compare a correlation coefficient in the normal class and a correlation coefficient in the disease class for each of available gene pairs on the microarray data set and selectively determine the gene pair as the disease specific gene pair in accordance with the comparison result.

Herein, the extractor may judge whether each of the available gene pairs on the microarray data set corresponds to a case in which absolute values of both the correlation coefficient in the normal class and the correlation coefficient in the disease class are larger than a first threshold value and signs of the coefficients are different from each other or a case in which an absolute value of only any one of the correlation coefficient in the normal class and the correlation coefficient in the disease class is larger than the first threshold value and a difference between the correlation coefficient in the normal class and the correlation coefficient in the disease class is larger than a second threshold value and selectively determine the gene pair as the disease specific gene pair in accordance with the judgment result.

Herein, the selector may select a gene corresponding to a herb node and a gene corresponding to a node connected to the herb node having the highest weight as the top specific gene pair among the extracted gene specific genes. At this time, the weight may be a value determined for each of the extracted disease specific gene pairs and a difference between an average value of difference values in slope between the samples in the normal class and an average value of difference values in slope between the samples in the disease class.

Herein, the test sample may belong to the plurality of samples, and the label predictor may predict the class label of the test sample by considering a difference between the correlation in the normal class concerning a plurality samples other than the test sample and the top specific gene pair and the correlation in the normal class concerning the plurality of samples including the test sample and the top specific gene pair and a difference between the correlation in the disease class concerning the plurality samples other than the test sample and the top specific gene pair and the correlation in the disease class concerning the plurality of samples including the test sample and the top specific gene pair. At this time, the extractor, the selector, and the label predictor may repetitively operate while updating a predetermined parameter value until the accuracy of the prediction of the label predictor for the test sample satisfies a predetermined reference. At this time, the parameter may include a first threshold value determining whether the gene pairs on the microarray data set have the strong correlation with each other, a second threshold value determining for each of the available gene pairs on the microarray data set, a value for determining whether there is a relevant difference between the correlation in the normal class and the correlation in the disease class, and the number of the top specific gene pairs.

Herein, the test sample may be an unknown sample that is not included in the plurality samples, and the label predictor may predict the class label of the test sample by considering a first difference between the correlation in the normal class concerning the plurality of samples on the microarray data set and the top specific gene pair and the correlation in the normal class concerning a result acquired by adding the test sample to the plurality of samples and the top specific gene pair and a second difference between the correlation in the disease class concerning the plurality samples and the top specific gene pair and the correlation in the disease class concerning the result acquired by adding the test sample to the plurality of samples and the top specific gene pair. At this time, the label predictor may determine the class label of the test sample as the disease class when the first difference is larger than the second difference. At this time, the label predictor may determine the class label of the test sample as the normal class when the second difference is larger than the first difference. At this time, the disease may be tumor.

In order to achieve another object, according to another embodiment of the present invention, a class label predicting method includes: extracting disease specific gene pairs from gene pairs on a microarray data set, which show expression levels for each of genes of a genome and for each of a plurality of samples by considering the correlation in a normal class and the correlation in a disease class; selecting a top specific gene pair having the highest correlation from the extracted disease specific genes; and predicting a class label of a predetermined test sample by using the selected top specific gene pair.

Herein, the extracting may compare a correlation coefficient in the normal class and a correlation coefficient in the disease class for each of available gene pairs on the microarray data set and selectively determine the gene pair as the disease specific gene pair in accordance with the comparison result.

Herein, the extracting may judge whether each of the available gene pairs on the microarray data set corresponds to a case in which absolute values of both the correlation coefficient in the normal class and the correlation coefficient in the disease class are larger than a first threshold value and signs of the coefficients are different from each other or a case in which an absolute value of only any one of the correlation coefficient in the normal class and the correlation coefficient in the disease class is larger than the first threshold value and a difference between the correlation coefficient in the normal class and the correlation coefficient in the disease class is larger than a second threshold value and selectively determine the gene pair as the disease specific gene pair in accordance with the judgment result.

Herein, the selecting may select a gene corresponding to a herb node and a gene corresponding to a node connected to the herb node having the highest weight as the top specific gene pair among the extracted gene specific genes. At this time, the weight may be a value determined for each of the extracted disease specific gene pairs and a difference between an average value of difference values in slope between the samples in the normal class and an average value of difference values in slope between the samples in the disease class.

Herein, the test sample may belong to the plurality of samples, and the predicting may predict the class label of the test sample by considering a difference between the correlation in the normal class concerning a plurality samples other than the test sample and the top specific gene pair and the correlation in the normal class concerning the plurality of samples including the test sample and the top specific gene pair and a difference between the correlation in the disease class concerning the plurality samples other than the test sample and the top specific gene pair and the correlation in the disease class concerning the plurality of samples including the test sample and the top specific gene pair. At this time, the extracting, the selecting, and the predicting may repetitively operate while updating a predetermined parameter value until the accuracy of the prediction of the label predictor for the test sample satisfies a predetermined reference. At this time, the parameter may include a first threshold value determining whether the gene pairs on the microarray data set have the strong correlation with each other, a second threshold value determining for each of the available gene pairs on the microarray data set, a value for determining whether there is a relevant difference between the correlation in the normal class and the correlation in the disease class, and the number of the top specific gene pairs.

Herein, the test sample may be an unknown sample that is not included in the plurality samples, and the predicting may predict the class label of the test sample by considering a first difference between the correlation in the normal class concerning the plurality of samples on the microarray data set and the top specific gene pair and the correlation in the normal class concerning a result acquired by adding the test sample to the plurality of samples and the top specific gene pair and a second difference between the correlation in the disease class concerning the plurality samples and the top specific gene pair and the correlation in the disease class concerning the result acquired by adding the test sample to the plurality of samples and the top specific gene pair. At this time, the predicting may determine the class label of the test sample as the disease class when the first difference is larger than the second difference. At this time, the predicting may determine the class label of the test sample as the normal class when the second difference is larger than the first difference.

In order to achieve yet another object, according to yet another embodiment of the present invention, a recording medium readable with a computer may store computer programs to execute extracting disease specific gene pairs from gene pairs on a microarray data set, which show expression levels for each of genes of a genome and for each of a plurality of samples by considering the correlation in a normal class and the correlation in a disease class; selecting a top specific gene pair having the highest correlation from the extracted disease specific genes; and predicting a class label of a predetermined test sample by using the selected top specific gene pair.

According to an embodiment of the present invention, it is possible to rapidly and accurately predict a class label of a predetermined test sample by extracting a disease specific gene pair from gene pairs on a microarray data set representing an expression level for each of genes of a genome and for each of a plurality of samples by considering the correlation in a normal class and the correlation in a disease class, selecting a top specific gene pair with the top correlation among the extracted disease specific genes, and predicting the class label of the predetermined test sample by using the selected the top specific gene pair.

### BRIEF DESCRIPTION OF THE DRAWINGS

FIG. 1 is a diagram for describing a microarray data set;

FIG. 2 is a block diagram of a class label predicting apparatus according to an embodiment of the present invention;

FIG. 3 is a diagram showing one example of a microarray data set for describing a device shown in FIG. 2;

FIG. 4 is a flowchart showing a class label predicting method according to an embodiment of the present invention; and

FIG. 5 is another flowchart showing a class label predicting method according to an embodiment of the present invention.

### DETAILED DESCRIPTION OF THE PREFERRED EMBODIMENTS

The accompanying drawings illustrating embodiments of the present invention and contents described in the accompanying drawings should be referenced in order to fully appreciate operational advantages of the present invention and objects achieved by the preferred embodiments of the present invention.

Hereinafter, a class label predicting apparatus and a class label predicting method according to embodiments of the present invention will be described below with reference to the accompanying drawings.

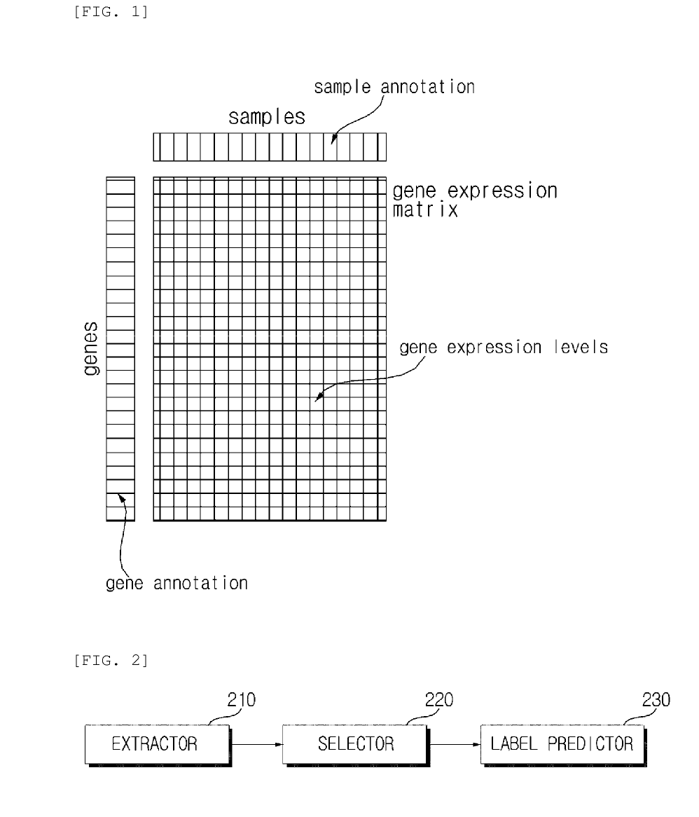

FIG. 1 is a diagram for describing a microarray data set.

As described above, the ‘microarray data set’ means array-type data representing an expression level for ‘each of genes of a genome’ and for ‘each of a plurality of samples’. In the specification, the ‘sample’ means a genome of a predetermined living body (i.e., human body). As shown in FIG. 1, each row of the microarray data set means individual genes and each column of the microarray data set means individual samples.

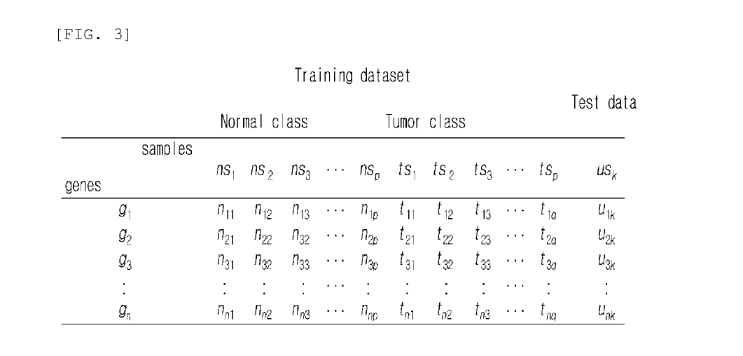

FIG. 2 is a block diagram of a class label predicting apparatus according to an embodiment of the present invention. The class label predicting apparatus includes an extractor 210, a selector 220, and a label predictor 230.

The extractor 210 extracts a disease specific pair from gene pairs on the microarray data set by considering ‘the correlation in a normal class’ and ‘the correlation in a disease class’. In the specification, the disease specific gene pair means a relevant gene pair in predicting a class label among the genes on the microarray data set. Meanwhile, contents of the disease may be various, but the disease will be described assuming that the disease is tumor for convenience of description. Therefore, the disease specific gene pairs are referred to as tumor specific gene pairs. On the other hand, in the specification, that a class label of a predetermined sample is the normal class indicates that the sample is a normal sample that does not get the disease (i.e., tumor) and the disease class indicates that the sample gets the disease.

Specifically, the extractor 210 compares ‘a correlation coefficient in the normal class’ and ‘a correlation coefficient in the disease class’ for each of available gene pairs on the microarray data set with each other and may selectively determine the gene pair as the disease specific gene pair according to the comparison result. The Spearman's correction coefficient is one example of the correlation coefficient. At this time, the spearman's correlation coefficient is disclosed in detail in Lehmann E. S. D'Abrera, H. J. M, “Nonparametrics: Statistical Methods Based on Ranks”, Prentice-Hall, Englewood Cliffs, N.J., pp. 292-300, and 323, 1998 (Pearson. K, “Mathematical contributions to the theory of evolutions. III. Regression, heredity and panmixia”, Philosophical Transactions of the Royal Society of London. Series A. pp. 253-318, 1896.).

More specifically, the extractor 210 judges whether each of the available gene pairs on the microarray data set corresponds to a case in which absolute values of both ‘the correlation coefficient in the normal class’ and ‘the correlation coefficient in the disease class’ are larger than a first threshold value and signs of the coefficients are different from each other or a case in which an absolute value of only any one of ‘the correlation coefficient in the normal class’ and ‘the correlation coefficient in the disease class’ is larger than the first threshold value and a difference between ‘the correlation coefficient in the normal class’ and ‘the correlation coefficient in the disease class’ is larger than a second threshold value and when the extractor 210 judges that any of the gene pairs corresponds to the cases, the extractor 210 determines the corresponding gene pair as the disease specific gene pair. In the specification, both the first threshold value and the second threshold value are predetermined parameter values. The first threshold value is a threshold value indicating whether the genes constituting the gene pair have the strong correlation with each other for each of the available gene pairs on the microarray data set and at this time, the gene pair may be a gene pair in the normal class or a gene pair in the normal class. Meanwhile, the second threshold value means a value for determining whether there is a relevant difference between the correlation in the normal class and the correlation in the disease class, that is, when ‘a correlation coefficient between genes constituting a predetermined gene pair as the correlation coefficient in the normal class’ and ‘a correlation coefficient between genes constituting a predetermined gene pair as the correlation coefficient in the disease class’ are different from each other, a value indicating the level of a difference for determining the predetermined gene pair as the disease specific gene pair.

The selector 220 selects ‘top specific gene pairs’ which are ‘gene pairs having top correlation’ from the disease specific genes extracted by the extractor 210. The ‘top specific gene pairs’ mean ‘genes corresponding a herb node’ and ‘genes corresponding to a node connected to the herb node through an edge having the highest weight’ among the disease specific genes extracted by the extractor 210. Each of the extracted disease specific genes corresponds to the node, the herb node means a node connected with the most edges among the extracted disease specific genes, that is, the nodes, and the weight of the edge connecting the node and the node is a value determined for each of the extracted disease specific gene pairs, specifically, means a difference between an average value of difference values in slope between the samples in the normal class and an average value of difference values in slope between the samples in the disease class. The top specific gene pair selected by the selector 220 is a predetermined number K. For example, if K=2, the selector 220 selects two ‘top specific gene pairs’ such as one ‘top specific gene pair’ including a gene corresponding to a ‘first herb node’ connected with the most edges and a gene corresponding to a ‘node connected to the first herb node through the edge having the highest weight’ among the disease specific genes extracted by the extractor 210, that is, the nodes and another ‘top specific gene pair’ including a ‘second herb node’ connected with the second most edges and a gene corresponding to ‘a node connected to the second herb node’ through the edge having the highest weight. The ‘top specific gene pair’ serves as a classifier in the present invention.

The label predictor 230 predicts a class label of a predetermined test sample by using the top specific gene pair selected by the selector 220. That is, the label predictor 230 predicts whether the class label of the predetermined test sample is the normal class or the disease class by the top specific gene pair selected by the selector 220.

The label predictor 230 may generally operate in one status between two statuses.

In the case of the first status, under a status in which the test sample belongs to the samples on the microarray data set and it is already known whether the class label of the test sample is the normal class or the disease class and the label predictor 230 performs N-fold cross validation, predicts the class label of the test sample under a predetermined parameter value for the top specific gene pair selected by the selector 220. If the accuracy of the prediction does not satisfy a predetermined reference, the label predictor 230 updates the parameter value until the accuracy of the prediction satisfies the reference, and the extractor 210, the selector 220, and the label predictor 230 operates again.

Herein, the predetermined parameter includes the above-mentioned first threshold value, the above-mentioned second threshold value, and the number (the above-mentioned K) of ‘the top specific gene pairs’ selected by the selector 220.

The N-fold cross validation means that predetermined N samples among samples (total M (however, M is an integer of 2 or more)) on the microarray data set are selected as the test sample (of course, at this time, a tester knows N samples among M samples) and the label predictor 230 predicts the class label of each of the N samples by using the top specific gene pair for the rest samples other than the N samples among the M samples.

Specifically, the label predictor 230 predicts the class label of the test sample by considering a difference (in this paragraph, hereinafter, referred to as ‘a difference’) between “the correlation in the normal class” concerning ‘a plurality samples (known samples)’ other than ‘the test sample (known sample)’ and ‘the top specific gene pair’ and “the correlation in the normal class” concerning ‘the plurality of samples (known sample) including the test sample’ and ‘the top specific gene pair’ and a difference (in this paragraph, hereinafter, referred to as ‘a second difference’) between “the correlation in the disease class” concerning ‘the plurality samples’ other than ‘the test sample’ and ‘the top specific gene pair’ and “the correlation in the disease class” concerning ‘the plurality of samples including the test sample’ and ‘the top specific gene pair’. More specifically, when the first difference is larger than the second difference, the label predictor 230 determines the class label of the test sample as the disease class, that is, predicts the class label of the test sample as the disease class and when the second difference is larger than the first difference, the label predictor 230 determines the class label of the test sample as the normal class, that is, predicts the class label of the test sample as the normal class.

In the case of the first status, since each of the test samples is not an unknown sample but is a sample in which information on a class label is also already known, the accuracy of the class label predicted by the label predictor 230 according to the N-fold cross validation can clearly be known and as a result, until the calculated accuracy satisfies a predetermined reference, the above-mentioned parameter values are updated and the extractor 210, the selector 220, and the label predictor 230 can repetitively operate. A parameter value when the repetitive operation stops is referred to as ‘an optimal parameter value’.

Meanwhile, in the case of the second status, under a status in which the test sample is not a sample that belongs to the samples on the microarray data set but an unknown sample, that is, a status in which whether the class label of the test sample is the normal class or the disease class is never known, the label predictor 230 predicts the class label of the test sample.

More specifically, the extractor 210 operates under ‘the optimal parameter value’, the selector 220 selects the top specific gene pair among the disease specific genes extracted by the extractor 210, and the label predictor 230 predicts the class label of the test sample by considering a difference (in this paragraph, hereinafter, referred to as ‘a third difference’) between “the correlation in the normal class” concerning ‘the plurality of samples (known samples) on the microarray data’ and ‘the top specific gene pair’ and “the correlation in the normal class” concerning ‘a result acquired by adding the test sample (unknown sample) to the plurality of samples (known samples)’ and ‘the top specific gene pair’ and a difference (in this paragraph, hereinafter, referred to as ‘a fourth difference’) between “the correlation in the disease class” concerning ‘the plurality samples’ and ‘the top specific gene pair’ and “the correlation in the disease class” concerning “the result acquired by adding the test sample to the plurality of samples’ and ‘the top specific gene pair’. More specifically, when the third difference is larger than the fourth difference, the label predictor 230 determines the class label of the test sample as the disease class, that is, predicts the class label of the test sample as the disease class and when the fourth difference, is larger than the third difference, the label predictor 230 determines the class label of the test sample as the normal class, that is, predicts the class label of the test sample as the normal class.

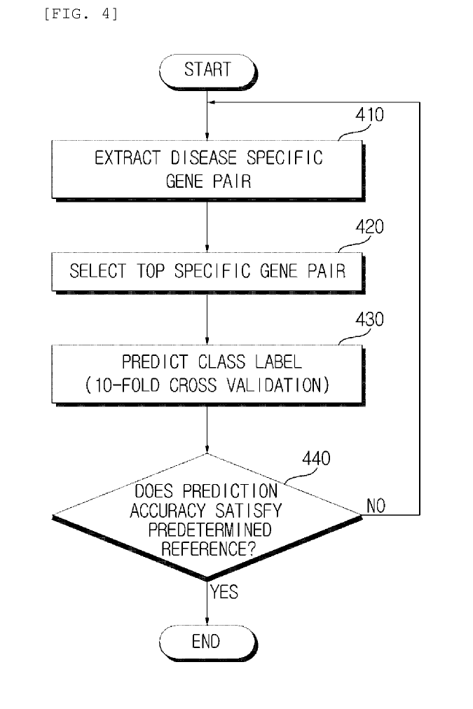

FIG. 3 is a diagram showing one example of a microarray data set for describing a device shown in FIG. 2, particularly, a label predictor 230. As shown in FIG. 3, nsᵢ means an i-th sample (however, i and p are integers of belonging to the normal class, tsⱼ means a j-th sample (however, j and q are integers of 1≦j≦q) belonging to the disease class, and gᵣ means an r-th gene (however, r and n are integers of 1≦r≦n). nᵢᵣ means an expression level of the i-th sample and the r-th gene in the normal class and tⱼᵣ an expression level of the j-th sample and the r-th gene in the disease class. uᵣₖ means an expression level of the r-th gene of the test sample.

The operation of the label predictor 230 will be described below by using FIG. 3. The label predictor calculates the third difference and the fourth difference for each of the disease specific gene pairs, and predicts the class label of the test sample as the disease class when the sum of the third differences is larger than the sum of the fourth differences, while predicts the class label of the test sample as the normal class when the sum of the fourth differences is larger than the sum of the third differences. This can be expressed by Equations 1 and 2 below.

$${ρ}_{n ( {g}_{1} , {g}_{2} )} = SCC [ ( {n}_{11} , {n}_{12} , … , {n}_{1 p} ) , ( {n}_{21} , {n}_{22} , … , {n}_{2 p} ) ] ↵ \\ {ρ}_{t ( {g}_{1} , {g}_{2} )} = SCC [ ( {t}_{11} , {t}_{12} , … , {t}_{1 q} ) , ( {t}_{11} , {t}_{12} , … , {t}_{1 q} ) ] ↵ \\ {ρ}_{n ( {g}_{1} , {g}_{2} )}^{′} = SCC [ ( {n}_{11} , {n}_{12} , … , {u}_{1 k} ) , ( {n}_{21} , {n}_{22} , … , {n}_{2 p} , {u}_{2 k} ) ] ↵ \\ {ρ}_{t ( {g}_{1} , {g}_{2} )}^{′} = SCC [ \begin{matrix}( {t}_{11} , {t}_{12} , … , {t}_{1 q} , {u}_{1 k} ) , \\ ( {t}_{11} , {t}_{12} , … , {t}_{1 q} , {u}_{2 k} )\end{matrix} ] ↵ \qquad [ Equation 1 ]$$

Herein, the first gene and the second gene are the disease specific gene pair, pₙ (g1, g2) means the Spearman's correlation coefficient between the first gene and the second gene concerning p samples (known samples) for the normal class, pₜ (g1, g2) means the Spearman's correlation coefficient between the first gene and the second gene concerning q samples (known samples) for the disease class, pₙ (g1, g2) means the Spearman's correlation coefficient between the first gene and the second gene concerning ‘p samples (known samples0 and test sample (unknown sample)’ for the normal class, and pₜ′ (g1, g2) means that Spearman's correlation coefficient between the first gene and the second gene concerning ‘q samples (known samples) and test sample (unknown sample)’ for the disease class.

$${N}_{diff} = {Σ}_{( {g}_{i} , {g}_{j} ) ∈ C} \vert {ρ}_{n} ( {g}_{i} , {g}_{j} ) - {ρ}_{n}^{′} ( {g}_{i} , {g}_{j} ) \vert ↵ \\ {T}_{diff} = {Σ}_{( {g}_{i} , {g}_{j} ) ∈ C} \vert {ρ}_{t} ( {g}_{i} , {g}_{j} ) - {ρ}_{t}^{′} ( {g}_{i} , {g}_{j} ) \vert ↵ \\ Prediction = \{ \begin{matrix}Normal if {N}_{diff} < {T}_{diff} \\ Tumor if {N}_{diff} \geq {T}_{diff}\end{matrix} \} ↵ \qquad [ Equation 2 ]$$

Herein, N_{diff} means the sum of the (above-mentioned) third differences for each of the disease specific gene pairs and T_{diff} means the sum of the fourth differences for each of the disease specific gene pairs.

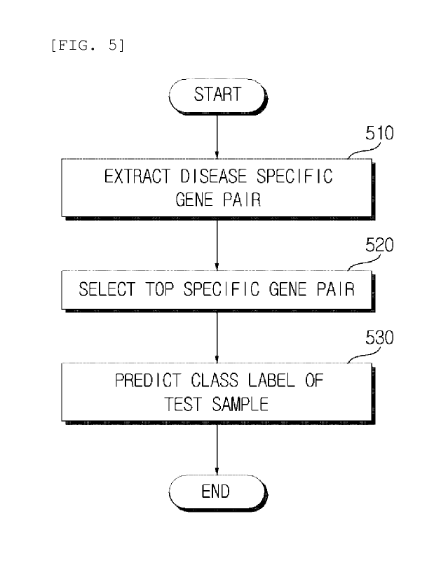

FIG. 4 is a flowchart showing a class label predicting method according to an embodiment of the present invention.

A class label predicting apparatus according to an embodiment of the present invention extracts ‘disease specific gene pairs (tumor specific gene pairs)’ by considering a correlation coefficient in a normal class and a correlation coefficient in a disease class among gene pairs on a microarray data set (step S410).

After step S410, the class label predicting apparatus according to the embodiment of the present invention selects a top specific gene pair having the highest correlation coefficient among the disease specific genes extracted at step S410 (step S420). Herein, the top specific gene pair means a gene corresponding to a herb node and a gene corresponding to a node connected to the herb node through an edge having the highest weight.

After step S420, the class label predicting apparatus according to the embodiment of the present invention predicts a class label of the test sample by using the top specific gene pair selected at step S420 (step S430). At step S430, the class label predicting apparatus according to the embodiment of the present invention performs label prediction according to N-fold cross validation (in FIG. 4, N=10 or conditionally). That is, at step S430, the label predictor according to the embodiment of the present invention predicts a class label of a predetermined test sample by considering a first difference between “the correlation in the normal class” concerning ‘a plurality samples (known samples)’ other than ‘10 test samples (known sample)’ and ‘the top specific gene pair’ and “the correlation in the normal class” concerning ‘the plurality of samples (known samples) including any one test sample among 10 test samples’ and ‘the top specific gene pair’ and a second difference between “the correlation in the disease class” concerning ‘the plurality samples’ other than ‘10 test samples’ and ‘the top specific gene pair’ and “the correlation in the disease class” concerning ‘the plurality of samples including any one sample’ and ‘the top specific gene pair’. More specifically, when the first difference is larger than the second difference, the label predictor according to the embodiment of the present invention determines the class label of any one test sample as the disease class, while when the second difference is larger than the first difference, the label predictor 230 determines the class label of any one test sample as the normal class.

Steps S410 to S430 are repetitively performed while the predetermined parameter values are updated until the accuracy of the prediction at step S430 satisfies a predetermined reference (see step S440).

FIG. 5 is another flowchart showing a class label predicting method according to an embodiment of the present invention.

A class label predicting apparatus according to an embodiment of the present invention extracts disease specific gene pairs (tumor specific gene pairs) among gene pairs on a microarray data set by considering a correlation coefficient in a normal class and a correlation coefficient in a disease class under an optimal parameter value (step S510).

After step S510, the class label predicting apparatus according to the embodiment of the present invention selects a top specific gene pair having the highest correlation coefficient among the disease specific genes extracted at step S510 (step S520). Herein, the top specific gene pair means a gene corresponding to a herb node and a gene corresponding to a node connected to the herb node through an edge having the highest weight.

After step S520, the class label predicting apparatus according to the embodiment of the present invention predicts a class label of a unknown test sample by using the top specific gene pair selected at step S520 (step S530). At step S530, the class label predicting apparatus according to the embodiment of the present invention predicts the class label of the test sample by considering a third difference between “the correlation in the normal class” concerning ‘a plurality samples (known samples) on the microarray data set’ and ‘the top specific gene pair’ and “the correlation in the normal class” concerning ‘a result acquired by adding the test sample (unknown sample) to the plurality of samples (known samples)’ and ‘the top specific gene pair’ and a fourth difference between “the correlation in the disease class” concerning ‘the plurality samples’ and ‘the top specific gene pair’ and “the correlation in the disease class” concerning ‘the result acquired by adding the test sample to the plurality of samples’ and ‘the top specific gene pair’. More specifically, when the third difference is larger than the fourth difference, the class label predicting apparatus according to the embodiment of the present invention determines the class label of the test sample as the disease class, while when the fourth difference is larger than the third difference, the class label predicting apparatus determines the class label of the test sample as the normal class.

Meanwhile, a program executing the class label predicting method according to the embodiment of the present invention may be stored in a computer-readable recording medium.

Herein, the computer-readable recording medium includes storage media such as magnetic storage media (i.e, ROM, floppy disk, hard disc, etc.) and optical reading media (i.e., CD-ROM and DVD (digital versatile disc), etc.).

Hitherto, the present invention has been described based on the preferred embodiments. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The protection scope of the present invention must be analyzed by the appended claims and it should be analyzed that all spirits within a scope equivalent thereto are included in the appended claims of the present invention.

1. A class label predicting apparatus, comprising:
an extractor configured to determine whether gene pairs each included in class-level-known samples is disease specific gene pairs based on a first correlation between genes paired in a normal class and a second correlation between the genes paired in a disease class;
a selector configured to select as a top specific gene pair a disease specific gene pair having the highest correlation among the disease specific gene pairs; and
a first label predicting configured to predict a class label of a given test sample whose class level is unknown by using the top specific gene pair,
wherein the extractor is configured to determines gene pairs in a class-level-known sample as the disease specific gene when any of genes paired satisfies a first case condition or a second case condition,
wherein the first case condition is that (i) an absolute value of a first correlation coefficient between the genes paired in the normal class is larger than a first threshold, (ii) an absolute value of a second correlation coefficient between the genes paired in a disease class is larger than the first threshold, and (iii) the first and the second correlation coefficients are different from each other, and
wherein the second case condition is that (i) an absolute value of any of the first and the second correlation coefficients is larger than the first threshold, and (ii) a difference between the first and the second correlation coefficients is larger than a second threshold.

2. The class label predicting apparatus according to claim 1, wherein the extractor is configured to, based on the first correlation coefficient and the second correlation coefficient, determine whether gene pairs included in the class-level-known samples each are the disease specific gene pairs.

3. (canceled)

4. The class label predicting apparatus according to claim 1, wherein the selector configured to select as the top specific gene pair a disease specific gene pair which is connected to a herb node or a node connected to the herb node through an edge having the highest weight.

5. The class label predicting apparatus according to claim 4, wherein the weight is a difference between (i) an average difference in slope between the class-level-known samples in the normal class and (ii) an average difference in slope between the class-level-known samples in the disease class.

6. The class label predicting apparatus according to claim 1,
wherein the first label predictor predicts a class label of the given test sample whose class level is unknown by considering a first parameter including a first difference and a second difference,
wherein the first difference is a difference between (i) a correlation in the normal class of the class-level-known samples excluding the given test sample and the top specific gene pair, and (ii) a correlation in the normal class of the class-level-known samples including the given test sample and the top specific gene pair, and
wherein the second difference is a difference between (i) a correlation in the disease class of the class-level-known samples excluding the given test sample and the top specific gene pair, and (ii) a correlation in the disease class of the class-level-known samples including the given test sample and the top specific gene pair.

7. The class label predicting apparatus according to claim 6, wherein the apparatus further comprising a second label predictor configured to repetitively update a second parameter including the first threshold, the second threshold and a number of the top specific gene pairs until the first parameter satisfies a given reference.

8. (canceled)

9. (canceled)

10. The class label predicting apparatus according to claim 6, wherein the first label predictor is configured to determine the class label of the given test sample as the disease class when the first difference is larger than the second difference.

11. The class label predicting apparatus according to claim 6, wherein the first label predictor determines the class label of the given test sample as the normal class when the second difference is larger than the first difference.

12. The class label predicting apparatus according to claim 1, wherein the disease is tumor.

13. A computer-implemented class label predicting method, comprising:
determining, using a processor, whether gene pairs each included in class-level-known samples is disease specific gene pairs, based on a first correlation between genes paired in a normal class and a second correlation between the genes paired in a disease class;
selecting, using a processor, as a top specific gene pair a disease specific gene pair having the highest correlation among the disease specific gene pairs;
receiving, using a processor, input information on a given test sample whose class level is unknown; and
performing, using a processor, first prediction predicting a class label of the given test sample whose class level is unknown by using the top specific gene pair,
wherein the step of determining includes determining gene pairs in a class-level-known sample as the disease specific gene when any of genes paired satisfies a first case condition or a second case condition,
wherein the first case condition is that (i) an absolute value of a first correlation coefficient between the genes paired in the normal class is larger than a first threshold, (ii) an absolute value of a second correlation coefficient between the genes paired in a disease class is larger than the first threshold, and (iii) the first and the second correlation coefficients are different from each other, and
wherein the second case condition is that (i) an absolute value of any of the first and the second correlation coefficients is larger than the first threshold, and (ii) a difference between the first and the second correlation coefficients is larger than a second threshold.

14. The computer-implemented class label predicting method according to claim 13, wherein the step of determining is configured to, based on the first correlation coefficient and the second correlation coefficient, determine whether gene pairs included in the class-level-known samples each are the disease specific gene pairs.

15. (canceled)

16. The computer-implemented class label predicting method according to claim 13, wherein the step of selecting includes selecting as the top specific gene pair a disease specific gene pair which is connected to a herb node or a node connected to the herb node through an edge having the highest weight.

17. The computer-implemented class label predicting method according to claim 16, wherein the weight is a difference between (i) an average difference in slope between the class-level-known samples in the normal class and (ii) an average difference in slope between the class-level-known samples in the disease class.

18. The computer-implemented class label predicting method according to claim 13,
wherein the step of performing first prediction includes predicting a class label of the given test sample whose class level is unknown by considering a first parameter including a first difference and a second difference,
wherein the first difference is a difference between (i) a correlation in the normal class of the class-level-known samples excluding the given test sample and the top specific gene pair, and (ii) a correlation in the normal class of the class-level-known samples including the given test sample and the top specific gene pair, and
wherein the second difference is a difference between (i) a correlation in the disease class of the class-level-known samples excluding the given test sample and the top specific gene pair, and (ii) a correlation in the disease class of the class-level-known samples including the given test sample and the top specific gene pair.

19. The computer-implemented class label predicting method according to claim 18, wherein the method further comprising performing second prediction configured to repetitively update a second parameter including the first threshold, the second threshold and a number of the top specific gene pairs until the first parameter satisfies a given reference.

20. (canceled)

21. (canceled)

22. The computer-implemented class label predicting method according to claim 18, Wherein performing the first prediction includes determining the class label of the given test sample as the disease class when the first difference is larger than the second difference.

23. The computer-implemented class label predicting method according to claim 18, wherein the first label predictor determines the class label of the given test sample as the normal class when the second difference is larger than the first difference.

24. A non-transitory computer readable medium, the non-transitory computer recording readable medium including:
a first code configured to determine whether gene pairs each included in class-level-known samples is disease specific gene pairs, based on a first correlation between genes paired in a normal class and a second correlation between the genes paired in a disease class;
a second code configured to select as a top specific gene pair a disease specific gene pair having the highest correlation among the disease specific gene pairs; and
a third code configured to predict a class label of a given test sample whose class level is unknown by using the top specific gene pair,
wherein the first code is configured to determines gene pairs in a class-level-known sample as the disease specific gene when any of genes paired satisfies a first case condition or a second case condition,
wherein the first case condition is that (i) an absolute value of a first correlation coefficient between the genes paired in the normal class is larger than a first threshold, (ii) an absolute value of a second correlation coefficient between the genes paired in a disease class is larger than the first threshold, and (iii) the first and the second correlation coefficients are different from each other, and
wherein the second case condition is that (i) an absolute value of any of the first and the second correlation coefficients is larger than the first threshold, and (ii) a difference between the first and the second correlation coefficients is larger than a second threshold.
